(19) United States
(12) Patent Application Publication
(10) Pub. No.: US 2018/0339214 A1
(43) Pub. Date: Nov. 29, 2018

(54) MACHINE LOGIC FOR TIMEOUT FORECASTING IN SPORTS AND COMPETITIVE GAMES

(71) Applicant: International Business Machines Corporation, Armonk, NY (US)

(72) Inventors: Aaron K. Baughman, Silver Spring, MD (US); Diwesh Pandey, Bangalore (IN); John P. Perrino, Hedgesville, WV (US); Todd R. Whitman, Bethany, CT (US)

(21) Appl. No.: 15/717,996

(22) Filed: Sep. 28, 2017

Related U.S. Application Data
(63) Continuation of application No. 15/605,296, filed on May 25, 2017.

(51) Int. Cl. A63B 71/06; G06N 5/04; A63B 24/00

(52) U.S. Cl. CPC A63B 71/0605; A63B 71/0616; A63B 71/0622; A63B 2024/0068; A63B 24/0062; A63B 2220/62; A63B 2225/50; G06N 5/04

(57) ABSTRACT

Machine logic (for example, software) for predicting the probability of a timeout being called at some time point during a sports contest. The machine logic considers injury and/or fatigue related input data, as well as many other types of input data (for example, various types of historical input data, various types of game specific input data generated after the sports contest begins). These predictions may be used for various purposes, such as play-calling decisions by sports coaches and predictive scheduling purposes by broadcast networks and/or advertisers.

### BACKGROUND

The present invention relates generally to the field of software for managing and/or scheduling in the context of competitive, organized contests (for example, sports contests).

“Sports contests” (see definition in Definitions sub-section, below) between competing multiple player teams are known. It is further known that some sports contests provide in their rules for the calling of “timeouts” (see definition, below, in Definitions sub-section). For example, in an American style football game, each team is given a certain number of timeouts which it can call. It is understood, at least in the context of football, that the selective calling/not calling of timeouts can have strategic importance. One known type of timeout is a television timeout. A television timeout is a televised sports contest to allow the showing of television commercials. In this way, commercial broadcasters can show commercials without causing television spectators of the sports contest to miss part of the contest play. The article “The Computerized Coach” (dated 31 Jan. 2009 and posted on the New York Times website) states as follows: “[A] computer program, Zeus, . . . assesses play-calling decisions of N.F.L. coaches, using the same modeling techniques that have revolutionized backgammon and chess. It's no different than I.B.M.'s supercomputer beating a skeptical Garry Kasparov in 1997. Built through research into game logs, statistics and the behavioral traits of coaches, Zeus accurately replicates a modern N.F.L. game. . . . Zeus, an analytical tool for the N.F.L. . . . is based on proven game theory strategies. The model analyzes the relative merits of critical play choices fourth downs, kickoffs and 2-point-conversion attempts. At any juncture, when facing a critical choice, Zeus will play the game to conclusion as many as a million times and determine the optimum choice, one that provides the highest Game Winning Chance. Zeus evaluations are not only sensitive to the teams' characteristics, but are also a function of score, ball position, yards to first down, clock and timeouts.”

### SUMMARY

According to an aspect of the present invention, there is a method, computer program product and/or system (for use in conjunction with a sports contest between a plurality of teams, with each team of the plurality of teams including a plurality of players, and with winning the sports contest is measured by which team is ahead in score at the end of the sports contest) that performs the following operations (not necessarily in the following order: (i) for each given time point of a set of time point(s) in the sports contest, receiving, by a computer, input data including, information indicative of: (a) probability of injury for each player of each of the plurality of teams at the given time point, (b) probability of a threshold amount fatigue for each player of each of the plurality of teams at the given time point, and (c) identity of which team of the plurality of teams is likely to be ahead in score at the given time point; and (ii) for each given time point of the set of time point(s) in the sports contest, processing, by the computer, the input data to determine a set of timeout probability value(s) (TPV(s)) corresponding to the given time point in advance of the given point in time, with the TPV(s) relating to a probability that a timeout will be called at the given time point in the sports contest.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a block diagram of a second embodiment of a system according to the present invention.

### DETAILED DESCRIPTION

Some embodiments of the present invention are directed to machine logic (for example, software) for predicting the probability of a timeout being called at some time point during a sports contest (see Definitions sub-section, below for definitions of “timeout,” “sports contest,” “time point,” “timeout probability value (TPV)”). In some embodiments, the machine logic considers injury and/or fatigue related input data. These predictions may be used for various purposes, such as play-calling decisions by sports coaches and predictive scheduling purposes by broadcast networks and/or advertisers. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

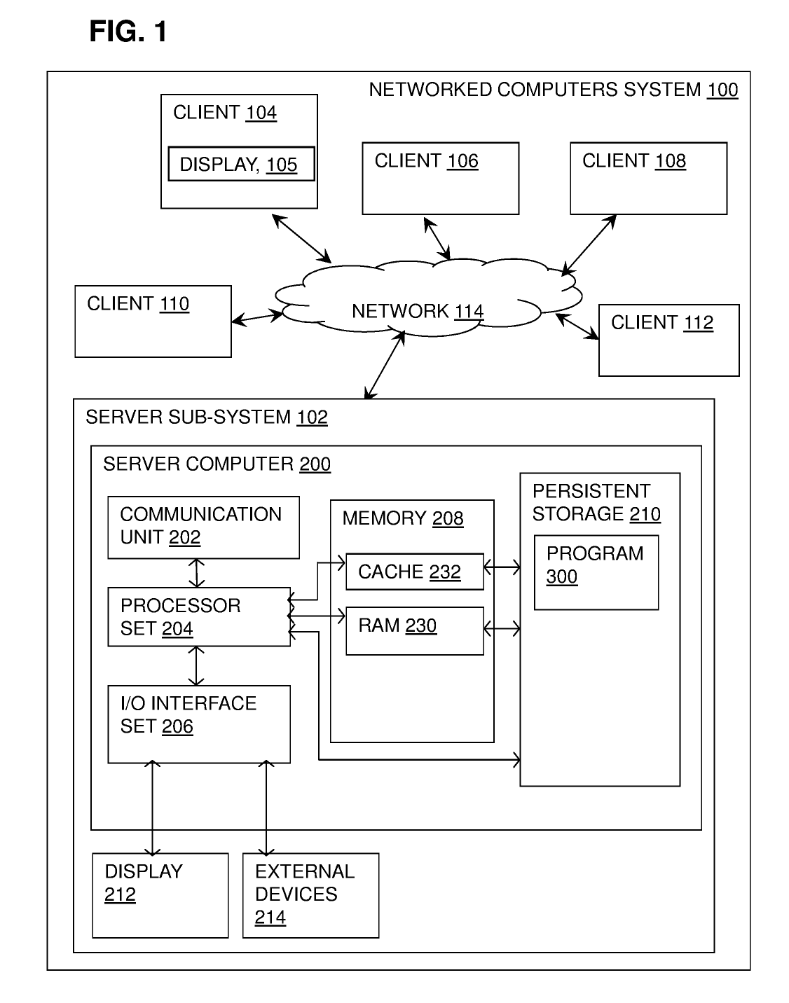

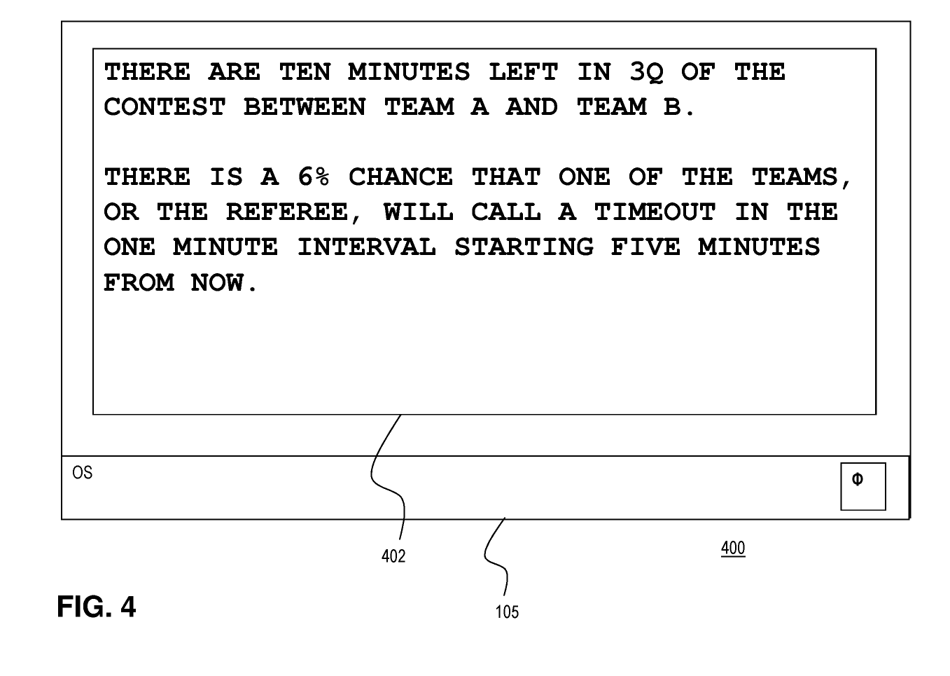

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems (sometimes herein referred to, more simply, as “clients”) 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300. As shown in FIGS. 1 and 4, client 104 includes: display 105; screenshot 400 and TPV 402.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

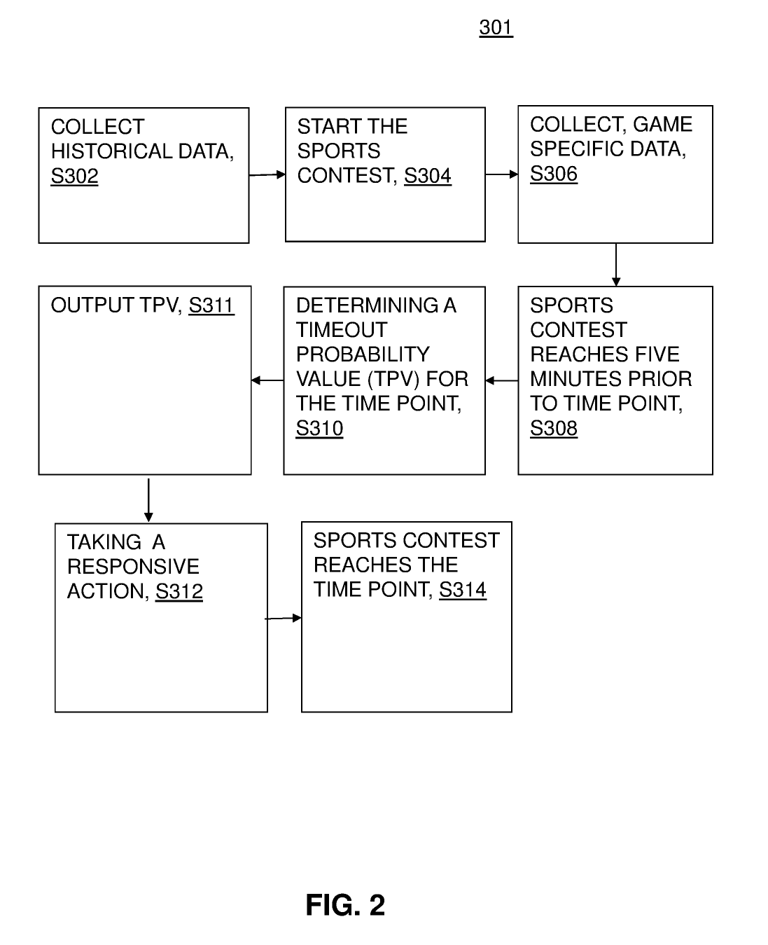

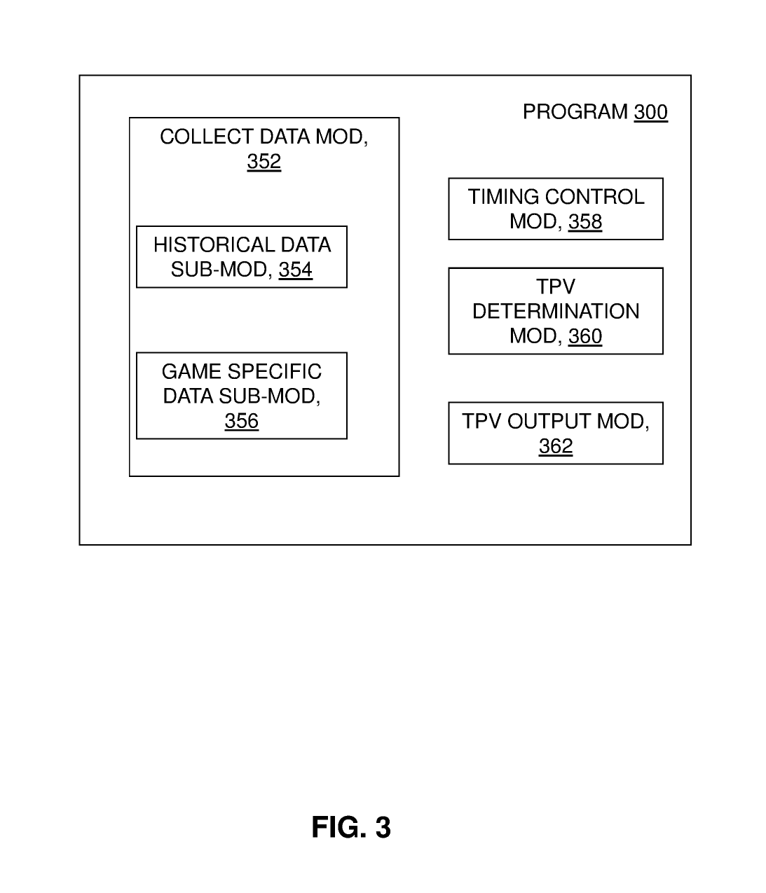

FIG. 2 shows flowchart 301 representing a method according to the present invention. FIG. 3 shows program 300 for performing at least some of the method operations of flowchart 301. This method and associated software will now be discussed, over the course of the following paragraphs, with extensive reference to FIG. 2 (for the method operation blocks) and FIG. 3 (for the software blocks). The method of flowchart 301 is a method to determine a probability that a timeout will be called in a given American style football game between five and four minutes left in the third quarter (that is, the “time point,” see definition, below, in the Definitions sub-section). In this example, the probability will be displayed to users five minutes before the start of the time point.

Processing begins at operation S302, where historical data sub-module (“sub-mod”) 354 of collect data mod 352 of program 300 of server computer 200 (see FIG. 1) collects historical data that may be relevant for attempting to predict when a timeout will be called in a given sports contest timeout. In this embodiment the historical data includes: (i) frequency with which the teams to be involved in the given sports contest have called timeouts in previous sports contests (sports contests against each other as well as sports contests against other teams); (ii) fatigue levels of team players when historic timeouts have been called by the teams in prior sports contests; (iii) injuries (type and severity level) of team players when historic timeouts have been called by the teams in prior sports contests; (iv) general health statistics on team players, especially as they relate to potential for fatigue (for example, data on the circumstances in which a given team player has been observed to fatigue during a previous sports contest); (v) general injury condition information for team players (for example, Player X on Team B suffered a groin pull three weeks ago); (vi) score information at time points when timeouts were called in previous sports contests; (vii) coach related information (for example, timeout calling proclivity information related to one of the team's coaches in his coaching of a previous team not to be involved in the given sports contest; (viii) weather forecast information; (ix) ticket sales and ticketholder personal profile information (for example, in this embodiment, 842 of the ticket buyers have been convicted of rioting and were only recently released from custody); (x) league standings (for example, Team B has been statistically eliminated from the playoffs and is likely to make late game substitutions to observe some players who normally “warm the bench”); (xi) historical social engagement (for example, player response and fan response); (xii) historically observed statistical relationships between timeout calling (in various game postures or contexts) and success in the sports contest; (xiii) historical mental and/or physical fatigue of the players; (xiv) historical referee related information; and/or (xv) information related to historically observed coach and/or player biases (for example, the biases may include: (1) confirmation bias, (2) fundamental attribution error, (3) bias blind spot, (4) anchoring bias, (5) representativeness bias, and/or (6) projection bias).

In this embodiment and as shown in FIG. 1, sub-mod 354 collects the historical data from a first database (not separately shown) stored in external devices set 214 of server sub-system 102, and from a second database (not separately shown) stored in client 106.

Processing proceeds to operation S304, where timing control mod 358 receives data indicating that players and officials have commenced the sports contest for which timeouts will be predicted by program 300. This point in time marks the break between: (i) “historical data” (as discussed, above, in connection with operation S302); and (ii) collection of “game specific data” (as will be discussed below in connection with the next operation of method 301). Alternatively, some embodiments: (i) use only historical data; or (ii) use only game specific data.

Processing proceeds to operation S306, where game-specific sub-mod 356 collects data which: (i) arises from the in-progress sports contest commenced at operation S304; and (ii) may be relevant for attempting to predict when a timeout will be called in a sports contest. In this embodiment, the game specific data comes from client 108 (see FIG. 1), which is the computer of a set of human observers whose job it is to collect information about the given sports contest that is now in progress in “real time.”

In this embodiment, the game specific data includes: (i) fatigue level information related to the various players of the teams now playing the given sports contest; (ii) injury related information related to the various players of the teams now playing the given sports contest; (iii) team performance related statistics (for example, team score, first downs, third down conversions, punt distances, punt return yardage averages, quarterback sacks, etc.); (iv) individual player performance related statistics (for example, rushing yards, downs played, time on field, number of tackles, number of times being tackled, etc.); (v) coach performance/behavior data (for example, coach's apparent mood, play calls made by coach, level of riskiness of coach's play-calling, etc.); (vi) fan related information (for example, crowd decibel level, attendance, etc.); and/or (vii) non-sports factor related (for example, weather, seismic data, locker-room incidents, etc.).

One type of game specific data used in this embodiment is relative score, which is to say which team is ahead and by how much, and also which team is expected to be ahead at various times during the given sports contest. Predictions of relative score can be determined based on both historical data and/or game specific data. In this embodiment, the machine logic is programmed such that relative score (actual or predicted) has a large influence over the probability as to whether a timeout will be called at some future point in the sports contest. This is because, in this embodiment, which relates to American style football, the status of a team as being ahead, or behind, tends to have a large influence over whether the team will call a timeout. In this embodiment, which team is currently ahead and by how much is the most important factor in predicting which team will be ahead at later times in the sports contest.

Processing proceeds to operation S308, where timing control mod 358 receives data indicating that the sports contest has reached a point in time that is five minutes prior to the time point (that is, the start of the one minute interval) for which program 300 is predicting the probability of a timeout being called. As mentioned above, in this example, the time of S308: (i) occurs five minutes prior to the specified time point; and (ii) would occur when there are ten (10) minutes left in the third quarter. Alternatively, the probability of a timeout being called may be predicted with respect to many time points during the game (for example, continuously over the entire course of the game). As a further alternative, the probability of having a timeout called at a single time point may be predicted at many different times in advance of the occurrence of the time point (for example, probability of a timeout called at a single given time point is continuously revised both prior to and over the course of a game).

It is important to point out that this embodiment deals with predicting timeouts (in a probabilistic manner). This means that the timeout probability is determined and communicated to users in advance of the time point to which the probability relates. This is different than systems where sports contests are simulated after they happen and timeouts are called as part of the simulation.

Responsive to the sports contest reaching ten (10) minutes left in the third quarter, processing proceeds to operation S310, where timeout probability value (TPV) mod 360 determines a TPV (see, definition, below, in Definitions section) for the time point based on: (i) the historical data collected at S302; and (ii) the game specific data collected at S306. In this embodiment, these calculations all occur within a fraction of a second, and can therefore be delayed until ten (10) minutes remain in the third quarter. Alternatively, if the calculations take longer, then they should at least commence in advance of the time when the TPV is needed. The next sub-section of this Detailed Description section discusses an algorithm for calculating TPV in more detail.

More specifically, in this embodiment, a TPV (based on a time point interval between five (5) and four (4) minutes left in the third quarter) is calculated using machine logic rules programmed into mod 360. These machine logic rules logically (for example if-then statements) and mathematically process the historical data inputs and the game specific inputs to calculate a TPV. In this embodiment, the TPV is expressed as a percentage. Alternatively, it may be more granular, or less granular (for example, a binary prediction that a timeout will be called or won't be called). In this embodiment, the TPV accounts for all types of timeouts, including those called by coaches, players and sports contest officials. Alternatively, some embodiments may predict only certain types of timeouts.

In this embodiment, the TPV is calculated to be 6 percent. In other words, a timeout seems pretty unlikely in the time interval between five (5) and four (4) minutes left in the third quarter of the sports contest (at least from a temporal vantage point at ten (10) minutes left in third quarter). However, it is noted that, generally speaking, timeouts are very seldom called in the third quarter of a football game, so, from that perspective, 6 percent is a somewhat large probability. In this example, there are a couple reasons for this relatively large percentage that will be discussed in the following two paragraphs.

In this example, the historical data, collected back at operation S302, shows that Coach Charlie, the coach of Team A calls timeouts during the time point between four (4) and five (5) minutes left in the third quarter when Team A is ahead with an unusually high frequency of 4.389 percent. Furthermore, the game specific input data, collected at operation S306, includes the relative score, which shows that Team A is ahead at the current time (that is ten minutes left in the third quarter) and has a relative large lead in score. Accordingly, one set of machine logic rule forecasts that Team A will be ahead in relative score at the time point between four (4) and five (5) minutes left in the third quarter. Additional machine logic rules, programmed into mod 360, determine that there is a 4.389 percent probability that Coach Charlie will call a timeout during the designated time point of this example. This is a large contributor to the relatively large six percent TPV.

In this example, the game specific input data further shows that there are a relative large number of spectators that have been previously arrested for rioting. The machine logic rules of mod 360 determine, based on this game specific input, that there is a 1.125 percent chance that officials will need to call a timeout during the designated time point in order to deal with disturbances among and between the spectators. Again, this probability is unusually high relative to most football contests. Other contributors besides the two identified in this paragraph and the previous paragraph are determined and added by the machine logic rules of mod 360. In this example, the aggregated probability is rounded down to six percent.

Processing proceeds to operation S311, where TPV output mod 362 outputs the TPV in human understandable form and format at approximately ten (10) minutes left in the third quarter (that is, five minutes before the specified time point). In this embodiment, the out of the TPV is shown at position 402 of screenshot 400 of display 105 of client 104 (see, FIGS. 1 and 4). In this example, client A is a tablet computer belonging to Nan, the nutritionist of Team A, who subscribes to the timeout prediction service to help her do her job. In various embodiments, this output of the TPV may take various forms, such as: (i) a visual display; (ii) an audio presentation; (iii) an email; and2/or (iv) a text message. In some embodiments that output may be in machine readable form and/or made to an artificial intelligence entity.

Processing proceeds to operation S312, where Nan: (i) mentally notes that 6 percent is a larger than usually probability for a timeout call in the third quarter; (ii) speculates that this large probability is a result of the fact that Coach Charlie calls timeouts in the third quarter more frequently than most coaches; (iii) asks Coach Charlie whether he will call a timeout this quarter; (iv) listens when Coach Charlie says that he is definitely not planning to call a timeout this quarter; and (v) responds to the low probability of a timeout five minutes from now by having Team A's players ingest quick energy paste (which provides a short duration burst of energy about five minutes of typical game time after it is ingested).

Processing proceeds to operation S314, where the sports contest reaches the time point (that is the designated one minute interval). In this instance Coach Baker, the coach of Team B observed the players of Team A eating the paste, and decides to call a timeout during the one minute interval, despite the fact that program 300 predicted that there was only a 6 percent chance that a timeout would be called in this interval. This means that Team A's players are bursting with nervous energy during the timeout, and this adversely affects their performance when the sports contest resumes after the energy burst is over and Team A's players are feeling a bit down and lethargic.

Although not shown in flow chart 301, historical data sub-mod 354 collects video that shows Coach Baker observing the opposing players eating the energy paste, and then, in apparent response, calling a timeout just when the effects of the energy paste are due to kick in. Based on this additional input, TPV determination mod 360 applies machine learning (ML) to add new machine logic rules which account for increased probability of a timeout five minutes after one coach observes players of the opposing team eating energy paste. In this way, the machine logic rules of mod 360 can improve over time and experience without substantial human intervention.

### III. Further Comments and/or Embodiments

Some embodiments of the present invention recognize the following facts, potential problems and/or potential areas for improvement with respect to the current state of the art: (i) during athletic strenuous activity, frequent breaks are required to level both emotional and physical for peak performance; and/or (ii) if such breaks are not called, injury or human error can generally increase.

Some embodiments of the present invention may include one, or more, of the following features, characteristics and/or advantages: (i) a system and method to forecast predictors into the future to determine when a timeout, break or commercial should be taken so that a team can rest; (ii) relative predictive value and importance will determine when to call for a timeout; (iii) in the opposite direction, a filter model will be used to compute the likelihood that an opponent or management team will call a timeout; (iv) as a result, we help teams reach and sustain their peak performance longer while reducing injury; (v) some embodiments solve similar problems for robotics hardware—that is, timeouts and breaks can be called for robots so that they can recharge their batteries or download the latest corpora or models; and/or (vi) as a result, robots will be able to perform at their peak within particular domains.

Some embodiments of the present invention may include one, or more, of the following features, characteristics and/or advantages: (i) assists robots and/or humans (who are increasingly working together within game and sport); (ii) game and sport decision-making entities teach each other and extend cognitive capabilities; (iii) a system and method to optimize the interaction between human and robotic, human performance and robotic activity; (iv) uses forecasting and predictors to determine when to call a break or timeout will ensure optimal performance for a longer period of time; (v) helps make decisions about opposing forces to assess the likelihood that they will call for a break thus eliminating the need to waste a timeout; (vi) forecasting of predictors to determine when a timeout, break or commercial should be called for Robots and Humans; (vii) short, medium and long term forecasters will be weighted based on predictor contribution and feature importance (for example, if player fatigue is not a huge predictor but injury is, then injury gets more weight since its more important); (viii) tradeoff analysis of forecasting to take a penalty or negative consequence to lessen global negative impact (for example, take a penalty to avoid team fatigue); and/or (ix) likelihood that an opposing team or entity will request a break as a predictor into a filter model.

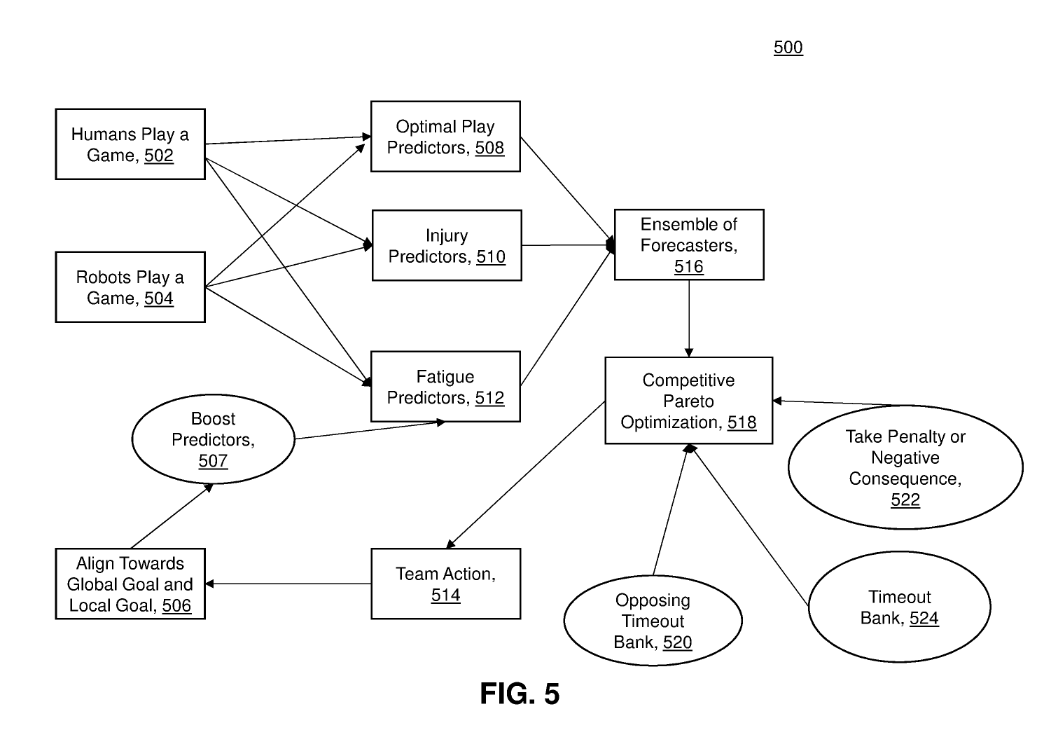

As shown in FIG. 5, block diagram 500 includes: humans play a game block 502; robots play a game block 504; align towards global goal and local goal block 506 (also sometimes herein referred to as align goal block); boost predictors block 507; optimal play predictors block 508; injury predictors block 510; fatigue predictors block 512; team action block 514; ensemble of forecasters block 516 (sometimes herein referred to as forecasters block); competitive Pareto optimization block 518; opposing timeout bank block 520 take penalty or negative consequence block 522 (sometimes herein referred to as penalty block); and timeout bank block 524.

Align goal block 506 will now be discussed in detail. The align goal block differentiates a global goal and a local goal based on a feature value and/or a predictor weight gain. For example, the align goal block monitors and maintains each player's health and injury level because the local goals are based, at least in part, on this information. In some embodiments, this monitoring and maintaining occurs both before the game and during the game. For example, a local goal would reflect the probability, and/or probabilistic benefit, of calling a timeout because there is a forecast of a probability of injury to a particular player (that is, the locus of the local goal). To explain this example a bit further, timeouts are likelier when it seems like a player may be becoming injured because the timeout affords an opportunity to make player replacements. In this embodiment, the determination of the global goal (based on combining the local goals) optimizes overall a weighted sum of all the predictors' weights. The global goal value corresponds to the likelihood that a timeout be called at a certain time (or range of times) during a game because the global goal is based on how the calling of a timeout is probabilistically related to helping (or hurting) the players of the team(s).

Boost predictors block 507 will now be discussed in detail. The boost predictors block changes the weight given to a timeout predictor value, so that the changed weight reflects analysis, rather than re-alignment, in the feedback loop. In other words, a dynamic weight is given to the predictor value so that a change in circumstance that corresponds to historical data during a game will still allow the local goals and global goals to be realized. The change in the weight given to a timeout predictor value will be assigned to the timeout predictor value based on the local goals and global goals of the team(s).

Optimal play predictors block 508 will now be discussed in detail. The optimal play predictors block creates a predictor model where robots and humans work together within a game or sporting event. The optimal play predictors block also defines a predictor weight (not to be confused with predictor value) based on an interaction between humans and robots. For example, based on an initial test case or historical data, if the desired outcome of a certain event (or local goal) for a human in a particular sporting event is determined to be thirty percent, and when a robot is later used to assist the human in the same sporting event, then the optimal play predictors block may estimate that the new desired outcome of the same event increases to sixty-five percent. One fundamental assumption involved in this example is that, in order to achieve the optimal outcome (or in other words, maximize the probabilistic chances of the local goal occurring), the cognitive capabilities of humans and robots should be in sync, and they should be aware of the decision making capabilities of the other. This fundamental assumption holds true because the overall goal is to optimize and enhance human and robotic performance and activity levels in a sporting event in a manner that allows the local goals to be harmonized to achieve the global goals.

Team action block 514 will now be discussed in detail. The team action block is used to make a decision regarding timeouts based on Pareto optimization. Using the team action block allows for an improved selection of certain targeted goals (such as local goals that correspond to team players) without worsening the other goals. In other words, by using the team action block, the predictor weight value corresponding to a particular player's local goal can be optimized in a manner that provides a helpful indication of when a timeout should be called, where the point in time in which a timeout is called does not decrease the predictor weight value corresponding to another player's local goal.

Forecasters block 516 will now be discussed in detail. The forecasters block is used to collect all of the input predictors, including input from: (i) the optimal play predictors block; (ii) the injury predictors block; and (iii) the fatigue predictors block; and (iv) bias predictor block. The forecasters block utilizes the collection of the input predictors as a repository for the competitive Pareto optimization block (discussed below).

Competitive Pareto optimization block 518 will now be discussed in detail. The competitive Pareto optimization block allocates resources, such as timeouts and penalties, among team members such that at least one criterion of the selected players improves without worsening at least one criterion of the non-selected players. Take, for example, a sporting event with two players on a given team (player A and player B). If at least one criterion of player A is to avoid getting injured and at least one criterion of player B is to avoid getting fatigued, then the competitive Pareto optimization block allocates the given resources, such as timeouts and penalties, in a manner that improves player A's criterion of avoiding injury without worsening player B's criterion of preventing fatigue. Additionally, the competitive Pareto optimization block allows an actor to prioritize non-dominated components. Also, this example is representative of the competitive Pareto optimization block.

Penalty block 522 will now be discussed in detail. The penalty block can be taken to reduce the global negative impact of the team. In other words, the penalty block is used to determine the optimal time in which to take a penalty to reduce the global negative impact of the team or increase the probabilistic chances of achieving the global goal. For example, the penalty block can be used to determine when a penalty should be taken to further a global goal, such as taking a penalty to avoid fatigue, which ultimately reduces the global negative impact of the team. In another example, the penalty block can be used to determine when a penalty should be taken further a global goal in the event that one team has run out of sanctioned timeouts and the only opportunity to create a break in the game is to take a penalty.

Timeout bank 524 will now be discussed in detail. The timeout bank is a collection of total available timeout options. A list with a few typical “timeout options” is as follows: (i) television related; (ii) fabricated injury; (iii) different length; (iv) filibuster/stall; (v) equipment malfunction; (vi) take a penalty; and (vii) force out of bounds. For example, the timeout bank can be utilized in conjunction with the penalty block to determine whether a penalty should be taken (for the purpose of reducing the negative global impact of the team) or whether an option provided in the list of timeout options should be taken. Timeout bank 524 is different from opposing timeout bank 520 because it is a consumption based timeout bank.

The operations blocks and other blocks of diagram 500 help illustrate many factors that may be considered in various embodiments of machine logic for predicting the timing of timeouts in a sports game or other competitive game.

Some embodiments of the present invention may include one, or more, of the following features, characteristics and/or advantages: (i) predicting a timeout for a robot, where a form of “robot” can include a driverless vehicle; (ii) considering the interaction between a driver and a vehicle (for example, when a vehicle has a human driver, and that vehicle is required to stop for re-fueling, then the fuel-stop is a form of “timeout” for the human driver because the driver suspends driving activities (like steering) during the time interval dedicated to the re-fueling); (iii) considering the interaction between humans and robots as a pair, where the humans and robots are part of a larger individual and group effort to achieve a goal (for example, in the re-fueling example above, the interaction of humans and robots could be part of the strategy for resting/refueling in a cross-country derby where there are multiple vehicles and drivers involved working as a team); and (iv) creating a forecast predictor model and Pareto optimization to achieve goals based on weighted predictors of players injury, fatigue, and/or human-robot interaction.

Some embodiments of the present invention may include one, or more, of the following features, characteristics and/or advantages: (i) forecasting of predictors to determine when a timeout, break or commercial should be called for Robots and Humans; (ii) predicting opponent strategy or monitoring the player's health/injury level and suggesting the optimal time for taking strategic timeout; (iii) can be used in products and/or services for the sporting goods product market; (iv) can be used in robotic software; (v) improves game and overall health of human and robots using strategic timeouts; (vi) creating a multi factor forecasting model based on players' injury, fatigue, battery life of robots, opposing team's strategy, etc.; and/or (vii) model for use in strategic timeouts to improve overall performance of the team.

Some embodiments of the present invention may include one, or more, of the following features, characteristics and/or advantages: (i) system to forecast timing of timeouts during event; (ii) repository of predictors of robot battery recharging requirements and of human rest requirements, both after strenuous activity; (iii) inputs to capture current activity of event; (iv) processor to weigh short, medium and long term forecasts based on predictor contribution and feature importance, and estimates of outside initiated timeouts made; and/or (v) providing a forecast of timing of needed timeouts.

Some embodiments of the present invention may include one, or more, of the following features, characteristics and/or advantages: (i) using the arithmetic mean of the local goal values to compute the global goal value; (ii) accumulating evidence as input for a probability density function that outputs a predicted value to be compared with the global goal value; (iii) weighting the predicted (or predictor) value based on the importance of the corresponding global goal; and/or (iv) ensuring that the predictor value is equivalent to the global goal value, and in the case where the predictor value is not equivalent to the global goal value, adjusting the predictor value to approximate the global goal value.

Some embodiments of the present invention may include one, or more, of the following features, characteristics and/or advantages: (i) adding restriction variables to the multivariable optimization problem, where the variables include certain embodiments of the present invention (discussed in the above paragraphs); (ii) utilizing restriction variables to define rules around each player that will have a sub goal (or local goal); and (iii) utilizing Pareto optimization to solve for the local and global goal values (for example, the restriction variables will place acceptable restrictions on local goal values (such as fatigue) on each player's fatigue measure, and the overall goal of winning the game will further change the restriction variables for the team based goals).

Some embodiments of the present invention may include one, or more, of the following features, characteristics and/or advantages: (i) including robotic games (such as Robocup); (ii) including a mixture of robotic and human games (such as robot wars); (iii) including predictions and/or forecasting with respect to the actions the other team will take; (iv) including social predictors (such as what the fans of the game are saying or doing); (v) including conflicting scenarios through Pareto optimal hulls; (vi) learning from humans (for example, a human can teach the system in play how it is doing since the games are state dependent); and/or (vii) including local goals for specific players and team goals.

### IV. Definitions

Sports contest: includes any competitive endeavor that requires at least two of the following criteria: (i) multiple groups (herein referred to as “teams”) of multiple entities (human and/or robot, herein called “players”) engaged as competitors in a physical activity, (ii) a non-negligible chance that at least some of the players could become injured and/or fatigued (that is, physically exhausted to an extent that the quality of the player's participation in the contest is substantially negatively impacted) by their participation in the contest, and/or (iii) has some form of scoring to evaluate the relative performance of the teams; contest objectives that are specific to a player are sometimes herein referred to as “local goals;” contest objectives that are specific to a team, considered as a whole, are sometimes herein referred to as “global goals;” some examples of “sports contests” are: badminton, soccer, cricket, team format robot fighting, team format auto racing, synchronized swimming, boxing, team format competitive lumberjacking, football; a game of croquet, as a sort of negative example, probably would not be considered as a “sports contest” unless it was played with such intensity that fatigue and injury to the players became a non-negligible possibility; the injury/fatigue may be virtual injury/fatigue to virtual players in a virtual “sports contest” (non-virtual sports contest with real world human and/or robot players may herein be specifically referred to as “real world sports contests”).

Timeout: a temporary discretionary stopping of the action in a sports contest; as a sort of negative example, a break between periods of a hockey game is not a timeout because it is mandated by the rules of the sport and therefore not discretionary; depending on the rules of the sport, timeouts may be called by team coaches, team players, contest officials and/or artificial intelligence entities (for example, in the context of a virtual sports contest); types of timeouts include: timeouts called to give a team a chance to relax and/or re-group (this type of timeout is the primary focus of some embodiments of the present invention), timeouts to remove an injured player from the field, timeouts to deal with unruly spectators, timeouts called for officiating reasons (for example, to review video of a close play by the officials), timeouts to deal with condition of the playing field, rink, ring, course, etc.

Time point: types of time points include: (i) a predetermined single point in time (for example, nine minutes and seventeen seconds into the second period); (ii) a predetermined time interval (for example, between 3:00 and 4:30 pm on day six of the team bicycle race); and/or (iii) time points defined by events likely to happen with in the sports contest (for example, the six inning of a baseball game, or between the time Team A reaches 10 points and the time Team A reaches 20 points in a basketball contest).

Timeout probability value (TPV): A forecasted quantification, at some level of granularity, that a timeout will be called at a time point in a real or virtual sports contest (for example, a forecast that a timeout is more likely than not to be called at some time point in a sports contest); when a sports simulator program, ZEUS (see Background section, above), calls or doesn't call a timeout in a virtual sports contest this is not a TPV because it is not a forecast of a probability of an uncertain future occurrence, but, rather, a definitive, affirmative decision about whether a timeout is, or is not, called at a time point.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method for use in conjunction with a sports contest between a plurality of teams, with each team of the plurality of teams including a plurality of players, and with winning the sports contest is measured by which team is ahead in score at the end of the sports contest, the method comprising:
for each given time point of a set of time point(s) in the sports contest, receiving, by a computer and from a historical sports-related data collection software module, input data including, information indicative of: (i) probability of injury for each player of each of the plurality of teams at the given time point, (ii) probability of a threshold amount fatigue for each player of each of the plurality of teams at the given time point, and (iii) identity of which team of the plurality of teams is likely to be ahead in score at the given time point;
for each given time point of the set of time point(s) in the sports contest, processing, by a timeout probability value(s) (TPV(s)) determination software module of the computer, the input data to determine a set of (TPV(s)) corresponding to the given time point in advance of the given point in time, with the TPV(s) relating to a probability that a timeout will be called at the given time point in the sports contest; and
taking a responsive action based on the set of TPV(s), with the responsive action including one of the following: calling a timeout, selecting to call a first type play of a plurality of types of play, selecting a first way of handling a penalty of a plurality of types of ways of handling penalties, scheduling an event, causing an equipment malfunction, fabricating an injury, and/or filibustering/stalling;
wherein:
the set of TPV(s) is in one of the following formats: (i) a single TPV value reflecting the probability that any team of the plurality of teams will call a timeout at the respectively corresponding time point, or (ii) a separate TPV value for each team of the plurality of teams reflecting the probability that the respectively corresponding team will call a timeout at the respectively corresponding time point;
the determination of the TPV(s) is based, at least in part, upon a Pareto optimality criterion;
the determination of the set(s) of TPV(s) includes: (i) for each given time point of the set of time point(s) in the sports contest, assigning local goal value(s) to at least some of the players based on the input data, (ii) for each given time point of the set of time point(s) in the sports contest, assigning global goal value(s) to at least one team based on the input data, and (iii) for each given time point of the set of time point(s) in the sports contest, determining a set of TPV(s) for the given time point in a manner based, at least in part, upon the local goal values for the given time point and the global goal value(s) for the given time point;
the input data further includes, for each given time point of the set of time point(s), information indicative of probable score of the game of the given time point;
for each given time point of the set of time point(s) in the sports contest, the determination of the set(s) of TPV(s) is based, at least in part, upon the probable score of the game at the given time point; and
the input data further includes, for each given time point of the set of time point(s), information indicative of an optimal play predictor weight that defines a probabilistic outcome when the players are assisted by robots during the sports contest.
